(19) United States
(12) Patent Application Publication
(10) Pub. No.: US 2003/0190058 A1
(43) Pub. Date: Oct. 9, 2003

(54) Apparatus and method for measuring queue length of vehicles

(75) Inventors: Joon Suk Jun, Suwon (KR); Sung Hoon Choi, Seoul (KR)

Correspondence Address: GREENBLUM & BERNSTEIN, P.L.C., 1950 ROLAND CLARKE PLACE, RESTON, VA, 20191, US

(73) Assignee: LG INDUSTRIAL SYSTEMS CO., LTD., Seoul (KR)

(21) Appl. No.: 10/393,937

(22) Filed: Mar. 24, 2003

(30) Foreign Application Priority Data
Apr. 4, 2002 (KR) 18701/2002

(51) Int. Cl. G06K 9/00

(52) U.S. Cl. 382/104; 340/937; 348/148

(57) ABSTRACT

In an apparatus and a method for measuring a queue length of vehicles, by installing a camera toward a direction same with a proceeding direction of vehicles on the road, photographing images of the road at the rear of vehicles and measuring a queue length of vehicles, it is possible to measure a queue length of vehicles accurately. The apparatus includes a camera for photographing the rear of vehicles on the road; an image converter for converting analog image signals corresponding to images photographed by the camera into digital image signals; and a control unit for extracting characteristics of vehicles from the converted digital images, calculating positions of vehicles on the road on the basis of the extracted characteristics and calculating a queue length of vehicles on the road on the basis of the calculated positions of vehicles.

### BACKGROUND OF THE INVENTION

1. Field of the Invention

The present invention relates to a traffic control system, and in particular to an apparatus and a method for measuring a queue length of vehicles.

2. Description of the Prior Art

In a traffic control system, a loop detector is used as a means for generating traffic information of roads or crossroads.

In the loop detector, a conductive coil is installed beneath the road surface, current flows on the coil, and existence of vehicle is detected by an electromagnetic induction phenomenon generated when the vehicle passes on the road surface. Accordingly, in one traffic lane, two coils are separately installed beneath the road surface, a speed of the vehicle is calculated by calculating detection time difference between the two coils, an occupancy time is obtained by calculating a representative value (namely, average value) of a time occupied by each coil, and a queue length of vehicles is calculated on the basis of the calculated speed and occupancy time.

A method for calculating a queue length of vehicles by using the loop detector provides information having high reliability about a traffic volume, an occupancy rate and speed information. However, because coils are installed beneath the road surface, it damages the road surface, and when the road surface condition is deteriorated, the coils may be cut. In addition, in repairing of the cut coils, it may cause traffic jam. In addition, recently necessity of information about a queue length of vehicles on a crossroads on the basis of not the conventional statistical control but present real-time traffic information through signal control in each intersection has been increased.

However, in order to acquire traffic information in a predetermined region such as a queue length of vehicles by using the loop detector, because several coils (loop coils) have to be installed beneath the road surface, construction thereof is difficult. Accordingly, in order to avoid difficulties of the loop coil installation construction, loop coils are installed at only several positions of the road (road surface) to calculate a queue length of vehicles. In that case, because a queue length is estimated by using position information of the loop coil installed at each position, accuracy of a queue length is lowered fundamentally.

In the meantime, in order to extract traffic information such as a traffic volume, a speed, an occupancy rate, a queue length of vehicles, etc., a technique using images has been developed and applied to the spot. In more detail, in traffic related fields, a CCTV (Closed Circuit Television) or a CCD (Charge-Coupled Device) camera is installed at major roads and crossroads in order to provide traffic information. In the meantime, an ATMS (Advanced Traffic Management System) as an ITS (Intelligent Traffic System) has been presented.

In the ATMS, in order to optimize traffic flow, by utilizing various traffic information detection techniques, traffic volume variation is detected in real-time, and various unforeseen circumstances on roads are recognized. According to that, the ATMS can grope control methods such as traffic signal lamp on/off time control, road capacity consideration and traffic flow control.

In the meantime, in order to recover defects of the loop detector as the conventional traffic information collecting sensor, researches on a traffic information collecting sensor using images as one of next generation traffic information collecting sensors has been performed actively.

In addition, researches on a vehicle queue length measuring method on the crossroad has been proceeded in order to use it for traffic signal lamp on/off time control, namely, signal control. The conventional method for measuring the vehicle queue length will be described with reference to accompanying FIG. 1.

FIG. 1 is a descriptive view illustrating a method for measuring a queue length of vehicles and error occurrence in a measured result in accordance with the conventional art.

As depicted in FIG. 1, a camera 100 is installed at a building near the crossroad or on a supporting column of a traffic signal lamp so as to have a predetermined height in order to get front images of vehicles advancing into the cross road.

In the conventional method for measuring a queue line of vehicles by using images, an image processing technique for discriminating vehicles from the road surface or additional noises is used. The conventional method is divided into a method for detecting vehicles by extracting contour components of the vehicles from images taken by a camera; and a method for setting, storing a reference image taken when there is no vehicle on the road under low air pollution condition, comparing the stored reference image with a present taken image in order to detect vehicles on the road.

However, as depicted in FIG. 1, in the conventional method, a lens of the camera is installed so as to face with the front surface of vehicles. In more detail, because the camera photographs the front of vehicles, concealed area may be occurred due to an angle between the camera and vehicles and a height of the vehicles, and accordingly error may occur between a true value of a queue length of vehicles and a measured value obtained by photographing and calculating.

In order to solve the above-mentioned problem, error can be compensated after measuring an accurate height of a vehicle and an accurate distance from the camera on the basis of the photographed images. However, because error may continually exist even in the height of the vehicle measured on the basis of the photographed images, it is fundamentally impossible to measure an accurate queue length of vehicles.

In addition, in order to compensate error of the measured queue length, it is possible to apply an arbitrary estimation value or a statistical value without calculating a height of each vehicle, however, error due to compensation in measuring of a queue length of vehicles may occur. In more detail, in the conventional techniques, by measuring a queue length of vehicles by photographing the front of vehicles, the higher a height of a vehicle or the longer a distance between a vehicle and a camera, error is increased geometrically.

In the meantime, by measuring a queue length at the front of vehicles, not only the above-mentioned geometrical error but also following measurement error may occur.

In the conventional techniques, two image processing methods have been presented. First method is for detecting a vehicle by extracting characteristics thereof as (vertical, horizontal and diagonal) edge elements or extracting a contour of the vehicle through those characteristics. Second method is for photographing and storing an image of an empty road as a reference image, comparing the reference image with a newly taken image, when difference exceeds a predetermined threshold value, it is determined there is a vehicle on the road. However, in the first image processing method, determining characteristic values of vehicles and a threshold value have to be performed as preconditions. In the second image processing method, because updating of a stored reference image is required according to time passage, a method for adjusting a threshold value has to be presented in order to detect a vehicle by using the updated reference value.

However, in those two image processing methods, under various road circumstances, there may be each case in which minute threshold value adjustment is required appropriately. Herein, if threshold value adjustment is wrongful, an accuracy is lowered sharply. For example, existence of vehicles may be misjudged as non-existence, or the opposite may be occurred.

In addition, in using of a reference image, namely, background image, when update of the background image is wrong, existence of vehicles may be misjudged in output, and accordingly detailed adjustment is required in order to obtain a good background image. However, because lots of vehicles pass on the road realistically, it is difficult to take a vehicle non-existence road image. If reference image update is continually failed, because update standards of a reference image can not be satisfied, an update time is delayed. Accordingly, when a reference image is not updated normally because of an abrupt atmospheric phenomenon (weather and brightness, etc.) change, there may be an error in judging of vehicle existence, and accordingly measurement error of a queue length is increased.

Hereinafter, measurement error in the image processing method will be described with reference to accompanying FIG. 2.

FIGS. 2A and 2B show a night road image photographed by the camera in FIG. 1 and a contour image thereof.

As depicted in FIG. 2A, in the conventional art, by photographing a road toward the front of a vehicle, in the image photographed at night (FIG. 2A), in a circular area (2A-1) far from the camera, light blurring phenomenon occurs due to direct light and reflected light of a headlight, contours of vehicles can not be shown, the whole image of the vehicles are covered by the lights, and accordingly a queue length measuring impossible area occurs.

In addition, on the road at night, because lighting condition is changed intensely, visibility of the contour of a vehicle is varied every 30 images (so called frames) per second, it is very difficult to discriminate light reflected from a body of the vehicle from light reflected from the road, as depicted in FIG. 2A, even in a region (2A-2) near to the camera in which light blurring phenomenon does not occur, headlights of vehicles are shown distinctly, however the outside of a vehicle is vaguely, only when surrounding light is reflected onto a vehicle, a contour distinguishable region can be generated.

Accordingly, as depicted in FIG. 2B, in an image photographed at night, because there is a region in which the contour of a vehicle can not be extracted accurately, a vehicle queue length measurable region is decreased, and accordingly among vehicles existed on the road the last vehicle can not be measured. Therefore, an accurate queue length of vehicles can not be measured fundamentally.

### SUMMARY OF THE INVENTION

In order to solve the above-mentioned problem, it is an object of the present invention to provide an apparatus and a method for measuring a queue length of vehicles capable of reducing measuring error of a queue length of vehicles by installing a camera lens toward a direction same with a proceeding direction of vehicles, photographing images of a road at the rear of vehicles and measuring a queue length of vehicles.

It is another object of the invention to provide an apparatus and a method for measuring a queue length of vehicles capable of solving accuracy lowering problem due to error occurred by geometrical concealment phenomenon, blurring phenomenon occurred by vehicle front lights at night and the indistinct contour of the rear of vehicle by installing a camera so as to photograph road images at the rear of vehicles.

It is yet another object of the invention to provide an apparatus and a method for measuring a queue length of vehicles capable of measuring a queue length of vehicles accurately by tracing characteristics of vehicles regardless of circumstances changes around the road.

In order to achieve the above-mentioned objects, an apparatus for measuring a queue length of vehicles in accordance with the present invention includes a camera for acquiring the rear image of vehicles on the road; an image converter for converting analog image signals corresponding to images acquired by the camera into digital image signals; and a control unit for extracting characteristics of vehicles from the converted digital images, calculating positions of vehicles on the road on the basis of the extracted characteristics and calculating a queue length of vehicles on the road on the basis of the calculated positions of vehicles.

In order to achieve the above-mentioned objects, a method for measuring a queue length of vehicles in accordance with the present invention includes acquiring the rear image of vehicles on the road; removing noise from the acquired images; extracting characteristics of vehicles from the noise-removed images and tracing the extracted characteristics; and determining the characteristics as stopped vehicles when moving trace of the characteristics is smaller than a predetermined size and calculating a distance from a position of the characteristics of the stopped vehicle to a reference position of a traffic lane on the road.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a descriptive view illustrating a method for measuring a queue length of vehicles and error occurrence in a measured result in accordance with the conventional art;

FIGS. 2A and 2B show a night road image photographed by the camera in FIG. 1 and a contour image thereof;

FIG. 3 is a block diagram illustrating an apparatus for measuring a queue length of vehicles in accordance with the present invention;

FIG. 4 is a block diagram illustrating a photographing direction of a camera for measuring a queue length of vehicles;

FIGS. 5A˜5D show road images acquired at day and night and the contours of the photographed images in accordance with the embodiments of the present invention;

FIG. 6A shows an original image in a circle in FIG. 5A;

FIG. 6B shows a noise-removed image in a circle in FIG. 5A;

FIGS. 7A˜7D show difference images (Gₓ, G_{y}) extracted from the noise-removed images;

FIG. 8 is an exemplary view illustrating a window size and a moving unit in tracing of characteristics; and

FIG. 9 shows a distance from a center mark of a circumscribed quadrangle to a stop line of a pertinent traffic lane.

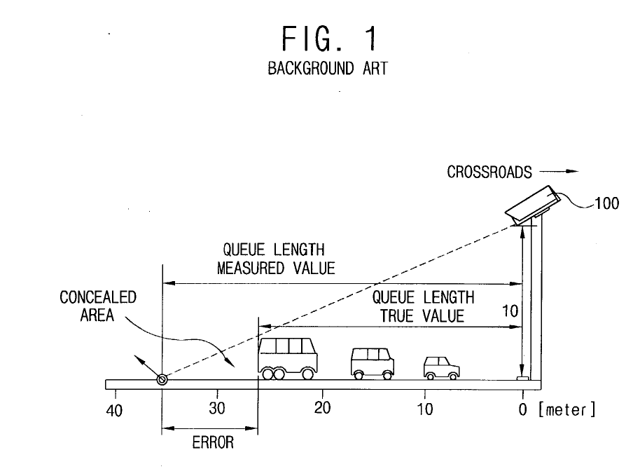

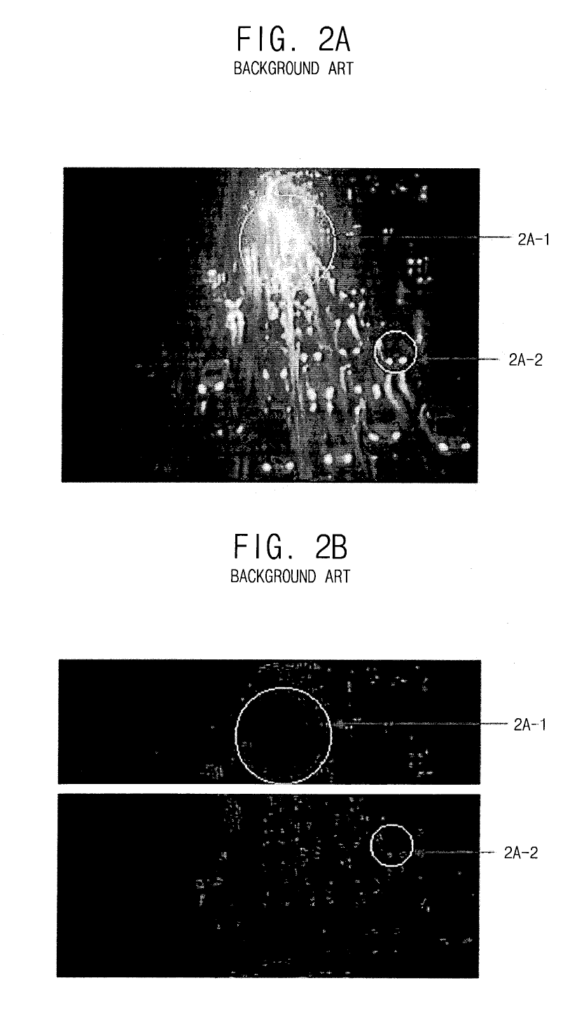

### DETAILED DESCRIPTION OF THE PREFERRED EMBODIMENT

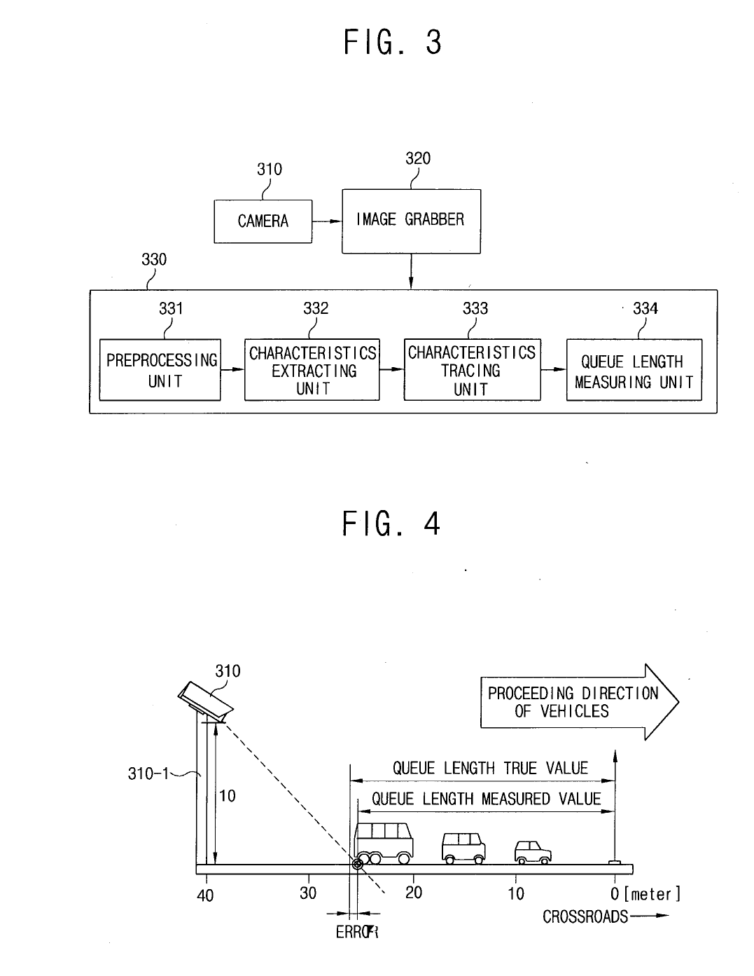

Hereinafter, the preferred embodiments of an apparatus and a method for measuring a queue length of vehicles capable of measuring a queue length of vehicles accurately by installing a camera so as to have the same direction with a proceeding direction of vehicles on the road and acquiring images of the road at the rear side of vehicles will be described in detail with reference to accompanying FIGS. 3˜9.

FIG. 3 is a block diagram illustrating an apparatus for measuring a queue length of vehicles in accordance with the present invention.

As depicted in FIG. 3, the apparatus for measuring a queue length of vehicles in accordance with the present invention includes a camera 310 for acquiring a road image at the rear side of vehicles on the road and transmitting (outputting) an analog image signal corresponding to the photographed road image through a coaxial cable; an image grabber 320 for converting the analog image signal received from the camera 320 into a digital image signal having 30 images (frames) per second; and a control unit 330 for storing the digital images converted in the image grabber 320 in a memory (not shown) by one frame and calculating a queue length of vehicles on the basis of the stored images. Herein, in the present invention, instead of the camera 310, it is possible to use various photographing means for photographing various moving pictures or still images, and instead of the image grabber 320 it is possible to use various image converters for converting analog image signals into digital image signals.

Hereinafter, a construction of the control unit 330 will be described in detail.

The control unit 330 includes a preprocessing unit 331 for removing noise by performing Gauss-filtering about digital images (frame data) converted in the image grabber 320 in the horizontal axis (X axis) and the vertical axis (Y axis) directions and outputting noise-removed images; a characteristics position extracting unit for respectively extracting a difference image in the horizontal axis (X axis) and the vertical axis (Y axis) from the images outputted from the preprocessing unit 331 and extracting characteristics (as the subject to be traced) such as a vertical line, a horizontal line, the edges, etc. by window units; a characteristics tracing unit 333 for setting characteristics positions extracted from the characteristics extracting unit 332 as a reference template, predicting the characteristics positions extracted from a next frame (an image inputted after proceeding a predetermined time) stored in the memory, determining the predicted positions part as a search region, calculating a correlation coefficient between the determined search region and the reference template by window units; template-matching a window having a maximum correlation coefficient value among the calculated correlation coefficient values (it means a window including the same image) and selecting the matched window as new characteristics; and a queue length measuring unit 334 for checking grouping characteristics by analyzing position relations among the characteristics selected from the characteristics searching unit 333, when the selected characteristics form groups, recognizing the characteristics as vehicles, when there is no motion not less than a predetermined size in the position trace of the characteristics recognized as the vehicles for predetermined frames, recognizing the characteristics forming the groups as stopped vehicles, calculating a maximum and a minimum positions of the characteristics of the stopped vehicles in the horizontal and vertical axes (X axis, Y axis), calculating a distance from the center mark of the maximum and minimum positions to a stop line in lanes of the road; and outputting the calculated distance value as a queue length value of vehicles.

Herein, the characteristics extracting unit 332 extracts the characteristics including a vertical line, a horizontal line and edge elements such as a diagonal line, etc. of the vehicle. Among plural groups having plural characteristics (each group means one stopped vehicle), the queue length measuring unit 334 calculates a distance from the last group (stopped vehicle) to a stop line in each traffic lane on the road. In addition, the stopped vehicle means the last stopped vehicle, namely, a vehicle placed far at the most from the stop line on the road. Accordingly, a distance from the last stopped vehicle (the nearest vehicle to the camera) to the stop line on the road is a queue length of vehicles.

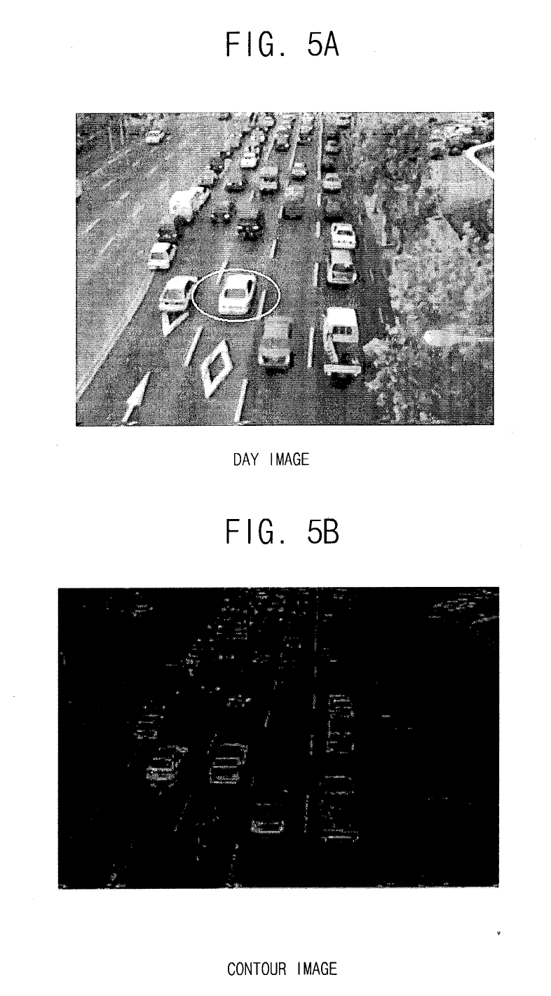

Hereinafter, the operation of the apparatus for measuring a queue length of the vehicle will be described in detail. First, the camera 310 as the image acquiring means will be described in detail with reference to accompanying FIG. 4.

FIG. 4 is a block diagram illustrating a photographing direction of the camera for measuring a queue length of vehicles.

As depicted in FIG. 4, the camera 310 in accordance with the present invention is installed at a predetermined height of an installation 310-1 on the road side in a photographing direction same with a proceeding direction of vehicles so as to have a FOV (field of view) appropriate to measuring of a queue length of vehicles. In more detail, the camera 310 is installed at the rear side of vehicles passing the road. Herein, as depicted in FIG. 4, when the camera 310 is installed and the road is photographed, the photographed road images show the rear of vehicles and roofs. Accordingly, in comparison with a case of photographing the rear of vehicles with the camera 310 in accordance with the present invention with a case for photographing the front of vehicles in accordance with the conventional art, the apparatus and method for measuring a queue length of vehicles in accordance with the present invention have at lest following four advantages.

1. It is possible to acquire the rear image of vehicles on the road and measure the last vehicle on the road easily from the acquired images, there is no need to consider or compensate a height up to a roof of a vehicle.

2. In acquiring of the rear image of vehicles on the road, there is fundamental error between a measured value in the acquired images and a true value in a queue length. However, because the error is according to a size of a wheel of a vehicle, it is much smaller than an error according to a height of a vehicle in the conventional art.

3. The longer a queue length of vehicles, the farther a distance from the last vehicle to a stop line of a crossroad, a distance from the last vehicle to the camera 310 is reduced, and a resolution of images is increased. Therefore an accuracy of a measured value is increased.

4. In photographing of vehicles on the road at night, by photographing not a headlight on the front but a tail light or a stop light on the rear, blurring phenomenon can be prevented, by distinguishing a vehicle from noise, it is possible to measure a queue length of vehicles accurately.

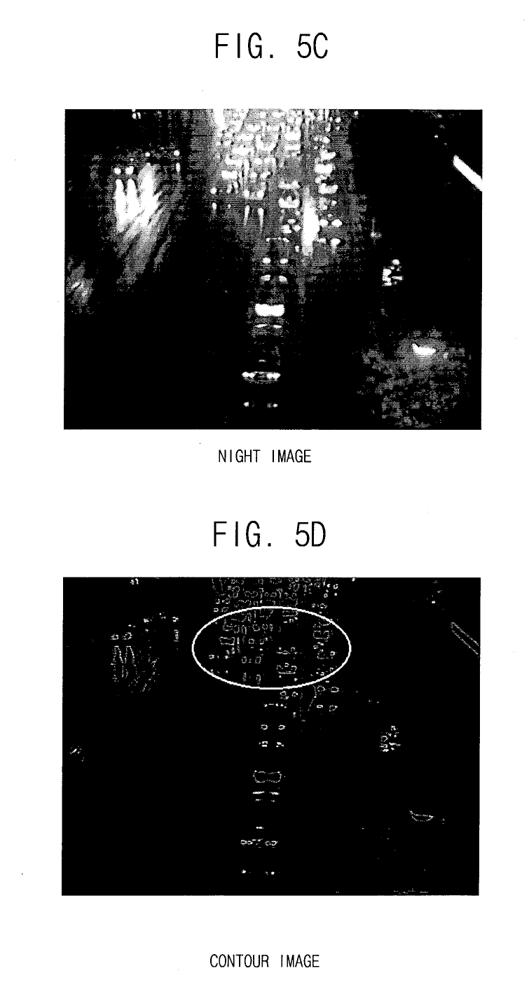

In order to have those advantages, the camera 310 photographs images of the road on the rear of vehicles, analog image signals corresponding to the acquired images are transmitted o the image grabber 320. Herein, day and night images photographed by the camera 310 will be described with reference to accompanying FIGS. 5A˜5D.

FIGS. 5A˜5D show road images photographed at day and night and the contours of the acquired images in accordance with the embodiment of the present invention. In more detail, FIGS. 5A and 5 C show the day and night images acquired by the camera 310. In addition, FIGS. 5B and 5D show the contour images of vehicles extracted from the day and night images photographed by the camera 310 by the image grabber 320.

The image grabber 320 converts the analog image signals outputted from the camera 310 into digital image signals in order to perform image processing, the converted digital image signals are stored in the memory region by frame units. Herein, images converted by the image grabber 320 are image frames in which each pixel has a 0˜255 black and white gray value, they are stored in a memory (not shown) of the control unit 330, and the stored image frames are updated at 30 frames per a second.

Afterward, the control unit 330 calculates a queue length of vehicles by image-processing the image frames in real-time. Herein, the processing process for calculating a queue length of vehicles are sequentially performed in the preprocessing unit 331, characteristics extracting unit 332, characteristics tracing unit 333 and queue length measuring unit 334, and it will be described in detail.

First, the preprocessing unit 331 removes noise element of the images received from the image grabber 320 by Gauss-filtering raw images of the digital images received from the image grabber 320 in the horizontal axis (X axis) and Gauss-filtering the Gauss-filtered images in the vertical axis (Y axis), and it transmits the noise-removed images to the characteristics extracting unit 332. Herein, the images received from the image grabber 320 are filtered through a Gauss filter (not shown), in selecting of weight applied to each pixel, weight according to Gaussian distribution (normal distribution) is applied. In more detail, by the Gauss filter, minute noise element of the images received from the preprocessing unit 331 is removed.

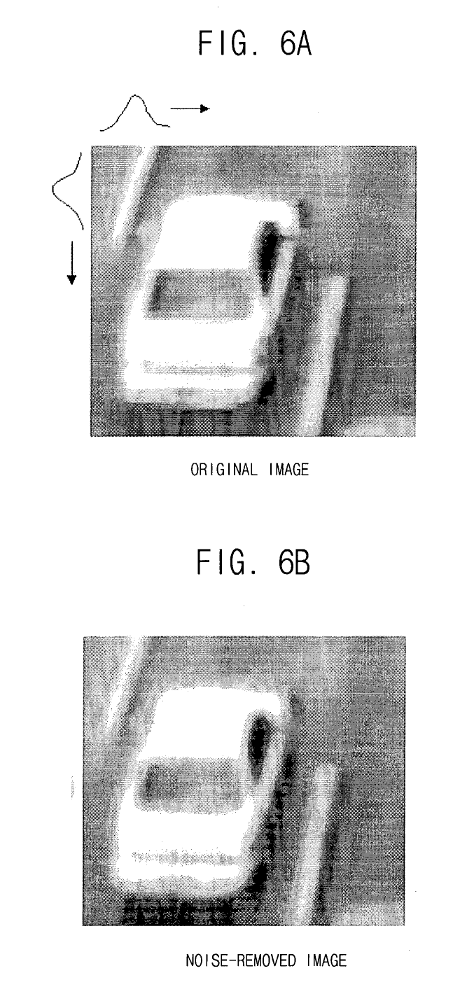

Hereinafter, original images photographed by the camera 310 and images obtained by removing noise element by filtering the original images through the Gauss filter in the horizontal and vertical axes will be described with reference to accompanying FIGS. 6A and 6B.

FIG. 6A shows an original image in a circle in FIG. 5A, and FIG. 6B shows a noise-removed image in a circle in FIG. 5A. In more detail, FIG. 6A shows the original photographed image, and FIG. 6B shows the image obtained by Gauss-filtering the original photographed image, namely, a noise-removed image.

Afterward, the characteristics extracting unit 332 extracts two space difference images (Gₓ, G_{y}) from the images received from the preprocessing unit 331 through a filter (not shown) having weight in order to extract characteristics of vehicles from the images (noise-removed images) received from the preprocessing unit 331.

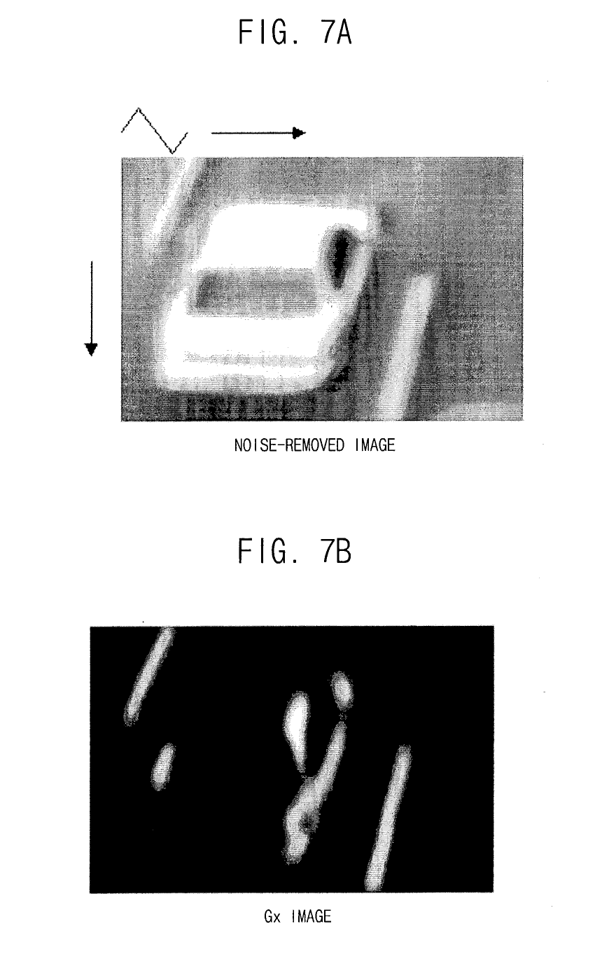

FIGS. 7A˜7D show the difference images (Gₓ, G_{y}) extracted from the noise-removed images.

As depicted in FIG. 7A, the characteristics extracting unit 332 performs filtering of the noise-removed image in the horizontal direction, and accordingly the space difference image (Gₓ) in the horizontal direction is obtained as depicted in FIG. 7B. In addition, as depicted in FIG. 7C, the characteristics extracting unit 332 performs filtering of the noise-removed image in the horizontal axis, and accordingly the space difference image (G_{y}) in the vertical direction is obtained.

In addition, the characteristics extracting unit 332 extracts characteristics as objects to be traced from the space difference images (Gₓ, G_{y}) obtained in the horizontal and vertical axes by window units having a certain size. In more detail, one characteristics has a certain window size. Herein, a characteristics value corresponding to a window characteristics can be calculated by following Equation 1.

$$\begin{matrix}WFV = \frac{( Sum\_gxx + Sum\_gyy - \sqrt{{( Sum\_gxx - Sum\_gyy )}^{2} + 4 Sum\_gxy} )}{2} \\ Sum\_gxx = {\sum }_{ = 1}^{W} gx \times gx \\ Sum\_gyy = {\sum }_{ = 1}^{W} gy \times gy \\ Sum\_gxy = {\sum }_{ = 1}^{W} gx \times gy\end{matrix} \qquad Equation 1$$

Herein, Sum_gxx is the sum total of square of each pixel in a window in the Gₓ image, Sum_gyy is the sum total of square of each pixel in a window in the G_{y} image, Sum_gxy is the sum total of values obtained by multiplying pixels in a window in the Gₓ image by pixels in a window placed on the same position in the G_{y} image, and w is a size of the window. In addition, a convolution function is used in order to extract characteristics from the original image, the convolution function is a set of pixels having a predetermined value, and it is also called “kernel”. In addition, Gₓ is the image through the “kernel” for obtaining the horizontal direction edges about all pixels of the original image, G_{y} is the image through the “kernel” for obtaining the vertical direction edges about all pixels of the original image.

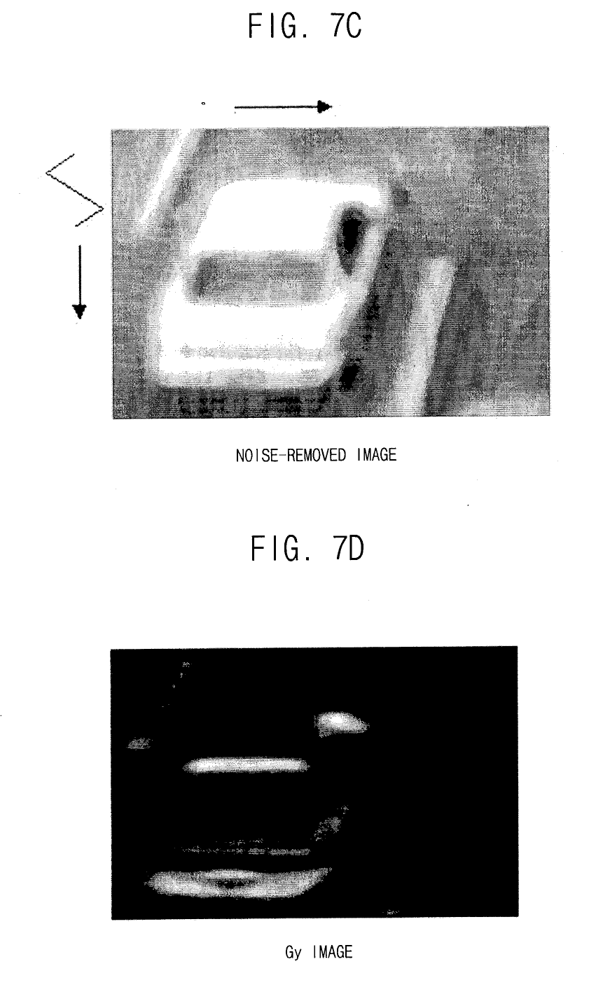

Hereinafter, a predetermined window size and a moving unit will be described with reference to accompanying FIG. 8.

FIG. 8 is an exemplary view illustrating a window size and a moving unit in tracing of characteristics. In more detail, in performing of an operation for calculating a predetermined value corresponding to characteristics by the window units, the window is moved to up/down and left/right. In more detail, the window is moved from the very left to the right by one pixel, when it reaches the very right, the window is moved to a lower pixel by 1 at the very left, and it is moved to the right again.

Accordingly, the characteristics extracting unit 332 calculates a characteristics value (WFV) by window units through Equation 1 and calculates a characteristics value as a tracing object through following process.

First, the characteristics extracting unit 332 compares whether the characteristics value (WFV) is greater than a threshold value (WFVₜₕ). The threshold value (WFVₜₕ) is set as lower as possible in order to detect the characteristics although it looks dimly in a cloudy day or at a time in which day is changed to night.

When the characteristics value (WFV) is greater than the threshold value (WFVₜₕ), the characteristics extracting unit 332 lines the characteristics value (WFV) greater than the threshold value (WFVₜₕ) in order of great value.

In addition, the characteristics extracting unit 332 compares the sequentially lined characteristics values (WFV) with previously selected characteristics values in order to check the similarity, it selects the predetermined-number of characteristics values in which windows are not coincided with each other and transmits the selected characteristics values to the characteristics tracing unit 333. Herein, according to circumstances change, by lining characteristics values greater than a threshold value (WFVₜₕ) and selecting the predetermined-number of characteristics values, it is possible to select characteristics values corresponding to characteristics including a vertical line, a horizontal line and the edge part. Herein, characteristics corresponding to the characteristics values are the tracing objets.

The characteristics tracing unit 333 sets positions of characteristics as a reference template, predicts positions of the characteristics in the present frame and determines positions of the predicted characteristics as a search region.

Afterward, the characteristics tracing unit 333 traces characteristics values by template-matching the determined search region with the reference template by window units. In more detail, the characteristics value tracing unit 333 sets a search region on the basis of positions of the extracted characteristics and determines characteristics not less than a predetermined threshold value as vehicles. Hereinafter, a method for tracing the characteristics will be described sequentially.

In the first step, the reference template is set. In more detail, characteristics selected in the characteristics value extracting unit 322, namely, images of the window including several pixels are set as the reference template. Herein, images received from the preprocessing unit 331 are used as the reference template images. The reference template unit of the selected characteristics is a window same with a unit in selecting characteristics.

Afterward, in the second step, a search region is determined. At first, a search region is determined by using a reference search region. Then, a position of a characteristics selected in the characteristics extracting unit 332 is predicted in a next frame by calculating a motion vector between a present position and a previous position, and a predetermined region including the predicted characteristics is determined as a search region.

Lastly, in the third step, a template-matching step is performed. In more detail, a correlation coefficient between the reference template window and a window in the search region is calculated. Herein, the calculated correlation coefficient value is in the range of −1˜1, the more the correlation coefficient value approaches 1, images existing in the window are similar to each other. In more detail, when the correlation coefficient value is 1, images existing in the window are the same (when the images are the same without any movement, it is determined as a stopped vehicle). The correlation coefficient value (γ) is calculated by following Equation 2.

$$\begin{matrix}γ = \frac{{S}_{xy}}{{S}_{x} {S}_{y}} , - 1 \leq γ \leq + 1 \\ {S}_{xy} = \frac{1}{n - 1} \sum ( {X}_{k} - \overline{X} ) ( {Y}_{k} - \overline{Y} ) \\ {S}_{x} = \sqrt{\frac{1}{n - 1} \sum {( {X}_{k} - \overline{X} )}^{2}} \\ {S}_{xy} = \sqrt{\frac{1}{n - 1} \sum {( {Y}_{k} - \overline{Y} )}^{2}}\end{matrix} \qquad Equation 2$$

Herein, γ is a correlation coefficient, Xₖ is a gray value of each pixel in the reference template, \overline{X} is an average value of Xₖ, Yₖ is a gray value of each pixel in a window in the search region, and \overline{Y} is an average value of Yₖ. Herein, when they are coincided with each other, a value calculated by Equation 2 is +1. When an absolute value of Xₖ, Yₖ is the same and a code is opposite, a value calculated by Equation 2 is +1. In other cases, a value calculated by Equation 2 is in the range of −1˜+1.

Accordingly, in the search region, the characteristics tracing unit 333 calculates a correlation coefficient of the reference template and the search region at each place by window units, selects a window having a maximum correlation coefficient (γ) among predetermined windows not less than a threshold value as new characteristics obtained through template-matching and outputs the selected characteristics to the queue length measuring unit 334.

In the meantime, in the third step, when there is no window having a correlation coefficient (γ) not less than a predetermined threshold value in the search region, tracing is failed, and accordingly tracing is stopped. On the contrary, when there is a window satisfying the condition, tracing is successful, and the first and second steps are performed repeatedly for tracing of a next frame.

Hereinafter, the operation of the queue length measuring unit 334 will be described in detail.

The queue length measuring unit 334 performs a step for determining a vehicle by checking grouping of characteristics successfully traced in the characteristics tracing unit 333; a step for judging whether the vehicle is in a moving state or a stop state by extracting trace information from the determined vehicle; and measuring a queue length of vehicles determined as in the stop state. The queue length measuring method will be sequentially described in detail.

First, the queue length measuring unit 334 analyzes position relations of successfully traced characteristics, recognizes characteristics separated not less than a predetermined distance as characteristics belonged to another vehicle and forms a new group. Herein, one group (including predetermined characteristics) means one vehicle.

Afterward, the queue length measuring unit 334 analyzes positions of all characteristics and divides the characteristics into a predetermined groups (one group means one vehicle), herein, only a group including not less than the predetermined-number of characteristics is recognized as a vehicle. In more detail, when the vehicle is determined through the grouping check, several characteristics are belonged to the one vehicle.

The queue length measuring unit 334 calculates the center of the several characteristics and records it at each frame. When the center position trace of the recorded characteristics is smaller than a predetermined size for the predetermined-number of consecutive frames, namely, there is no move, the group of the recorded characteristics is determined as a vehicle stopped on the road.

In addition, among vehicles determined as the stopped vehicles, the queue length measuring unit 334 calculates a maximum position and a minimum position of characteristics (group) belonged to the last stopped vehicle in the horizontal (X axis) and vertical (Y axis) axes, calculates a circumscribed quadrangle (it means a vehicle) on the basis of the calculated maximum and minimum position values and calculates a distance from the center of the circumscribed quadrangle to a stop line (or reference position) of each traffic lane.

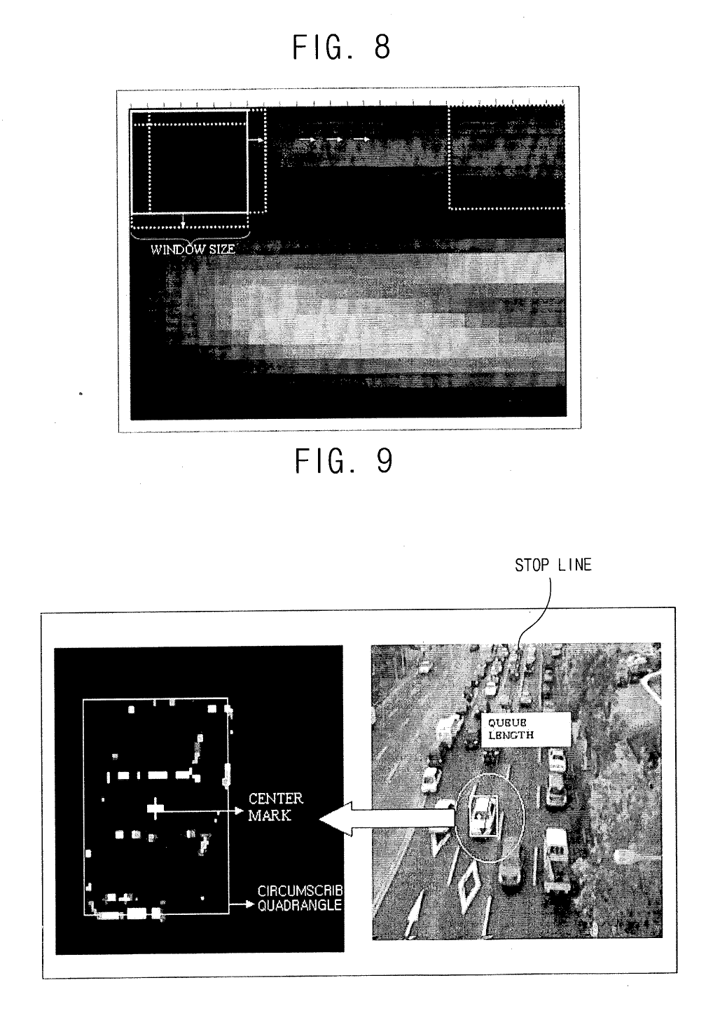

FIG. 9 shows a distance from a center mark of a circumscribed quadrangle to a stop line of a pertinent traffic lane. In more detail, a distance from a center mark of a circumscribed quadrangle to a stop line of a pertinent traffic lane means a queue length.

As described above, in the present invention, by installing a camera so as to photograph a queue length of vehicles at the rear position, it is possible to solve the accuracy lowering problem due to error occurred by geometrical concealment phenomenon, blurring phenomenon occurred by vehicle front lights at night and the indistinct contour of the rear of vehicle in the conventional art photographing the front images of vehicles. In more detail, in the present invention, by installing a camera so as to have a photographing direction same with a moving direction of vehicles, geometrical error occurred in measuring of the last vehicle on the road can be reduced, influences due to the front lamp or diffusion of reflected light at night can be removed, and accordingly it is possible to improve an accuracy of a queue length measured value.

In addition, by installing a camera so as to photograph a queue length of vehicles at the rear position, it is possible to reduce a measurement error of a queue length of vehicles.

In addition, in the present invention, it is possible to measure a queue length accurately by tracing characteristics regardless of circumstances around the road. In more detail, in the present invention, by determining whether vehicles on the road are stopped or moving instantly in real-time on the basis of characteristics of vehicles, it is possible to improve speed of queue length measuring.

In addition, in the present invention, by determining instantly whether vehicles on the road are stopped on the basis of characteristics of vehicles in real-time and measuring a queue length of the vehicles, there is no need to adjust a threshold value according to circumstances change or background updating, and accordingly it is possible to adjust a queue length of vehicles accurately.

What is claimed is:

1. An apparatus for measuring a queue length of vehicles, comprising:
a camera for acquiring the rear image of vehicles on the road;
an image converter for converting analog image signals corresponding to images acquired by the camera into digital image signals; and
a control unit for extracting characteristics of vehicles from the converted digital images, calculating positions of vehicles on the road on the basis of the extracted characteristics and calculating a queue length of vehicles on the road on the basis of the calculated positions of vehicles.

2. The apparatus of claim 1, wherein the control unit determines whether vehicles on the road are in a stopped state on the basis of the extracted characteristics and position trace thereof, calculates a distance from the stopped vehicles to a reference position of the road when the vehicles on the road are in the stopped state and outputs the calculated value as a queue length of the vehicles.

3. The apparatus of claim 1, wherein the control unit includes:
a preprocessing unit for removing noise of the converted digital images;
a characteristics extracting unit for extracting characteristics of vehicles from the noise-removed images by window units;
a characteristics tracing unit for setting a search region on the basis of positions of the extracted characteristics and recognizing characteristics not less than a predetermined threshold value in the set search region as vehicles; and
a queue length measuring unit for determining whether vehicles on the road are in a stopped state on the basis of positions of characteristics recognized as vehicles, calculating a distance from positions of characteristics of the stopped vehicles to a reference position of a traffic lane on the road and outputting the calculated distance value as a queue length value of the vehicles.

4. The apparatus of claim 3, wherein the characteristics include edge elements of a vertical line, a horizontal line and a diagonal line.

5. The apparatus of claim 3, wherein the preprocessing unit removes noise by filtering the converted digital images sequentially in the vertical and horizontal axes.

6. The apparatus of claim 3, wherein the characteristics extracting unit extracts a horizontal axis difference image (Gₓ), a vertical axis difference image (G_{y}) and calculates a characteristics value (WFV) corresponding to characteristics of a certain window unit by using the extracted difference images (Gₓ)(G_{y}).

7. The apparatus of claim 6, wherein the characteristics value (WFV) is calculated by following equation
$$\begin{matrix}WFV = \frac{( Sum\_gxx + Sum\_gyy - \sqrt{{( Sum\_gxx - Sum\_gyy )}^{2} + 4 Sum\_gxy} )}{2} \\ Sum\_gxx = {\sum }_{ = 1}^{W} gx \times gx \\ Sum\_gyy = {\sum }_{ = 1}^{W} gy \times gy \\ Sum\_gxy = {\sum }_{ = 1}^{W} gx \times gy\end{matrix}$$
wherein, Sum_gxx is the sum total of square of each pixel in a window in the Gₓ image, Sum_gyy is the sum total of square of each pixel in a window in the G_{y} image, and Sum_gxy is the sum total of values obtained by multiplying pixels in a window in the Gₓ image by pixels in a window placed on the same position in the G_{y} image.

8. The apparatus of claim 3, wherein the characteristics tracing unit sets positions of characteristics extracted from the characteristics extracting unit as a reference template; predicts positions of the extracted characteristics on a next digital image; determines the predicted position part as a search region, calculates a correlation coefficient between the search region determined by window units and the reference template; performs template-matching of a window having a maximum correlation coefficient value among the calculated correlation coefficient values; and selects the matched window as new characteristics.

9. The apparatus of claim 8, wherein the correlation coefficient (γ) is calculated by following equation
$$\begin{matrix}γ = \frac{{S}_{xy}}{{S}_{x} {S}_{y}} , - 1 \leq γ \leq + 1 \\ {S}_{xy} = \frac{1}{n - 1} \sum ( {X}_{k} - \overline{X} ) ( {Y}_{k} - \overline{Y} ) \\ {S}_{x} = \sqrt{\frac{1}{n - 1} \sum {( {X}_{k} - \overline{X} )}^{2}} \\ {S}_{xy} = \sqrt{\frac{1}{n - 1} \sum {( {Y}_{k} - \overline{Y} )}^{2}}\end{matrix}$$
wherein, γ is a correlation coefficient, Xₖ is a gray value of each pixel in a reference template window, \overline{X} is an average value of Xₖ, Yₖ is a gray value of each pixel in a window in the search region, and \overline{Y} is an average value of Yₖ.

10. The apparatus of claim 8, wherein the queue length measuring unit checks grouping of characteristics selected from the characteristics tracing unit according to position relations therebetween; determines the characteristics as vehicles when the selected characteristics form groups; determines the groups of the characteristics as stopped vehicles when the position trace of the characteristics determined as vehicles is smaller than a predetermined size for predetermined frames; calculates a maximum and a minimum positions of the characteristics of the stopped vehicles in the horizontal and vertical axes; calculates a distance from the center mark of the maximum and minimum positions to a reference position on a traffic lane of the road; and outputs the calculated distance value as a queue length value of the vehicles.

11. The apparatus of claim 1, wherein the control unit includes;
a preprocessing unit for removing noise by performing Gauss-filtering about digital images converted in the image grabber in the horizontal and vertical axes directions and outputting noise-removed images;
a characteristics extracting unit for respectively extracting a difference image in the horizontal axis and the vertical axis from the images outputted from the preprocessing unit and extracting characteristics of vehicles from the extracted difference images by window units;
a characteristics tracing unit for setting characteristics positions extracted from the characteristics extracting unit as a reference template, predicting the characteristics positions on a next frame stored in the memory, determining the predicted positions part as a search region, calculating a correlation coefficient between the determined search region and the reference template by window units, template-matching a window having a maximum correlation coefficient value among the calculated correlation coefficient values and selecting the template-matched window as new characteristics; and
a queue length measuring unit for recognizing the characteristics as vehicles when the characteristics selected from the characteristics tracing unit form groups, determining the characteristics forming the groups as stopped vehicles when position trace of the characteristics recognized as the vehicles is smaller than a size predetermined for predetermined frames, calculating a maximum and a minimum positions of the characteristics of the stopped vehicles in the horizontal and vertical axes, calculating a distance from the center mark of the maximum and minimum positions to a reference line on a traffic lane of the road; and outputting the calculated distance value as a queue length value of the vehicles.

12. A method for measuring a queue length of vehicles, comprising:
photographing the rear of vehicles on the road;
removing noise from the photographed images;
extracting characteristics of vehicles from the noise-removed images and tracing the extracted characteristics; and
determining the characteristics as stopped vehicles when moving trace of the characteristics is smaller than a predetermined size and calculating a distance from a position of the characteristics of the stopped vehicle to a reference position of a traffic lane on the road.

13. The method of claim 12, wherein the tracing step includes the sub-steps of:
calculating a difference image of the noise-removed image in the horizontal and vertical axes and extracting characteristics from the calculated difference images;
comparing whether the extracted characteristics value is greater than a predetermined threshold value;
lining characteristics values greater than the predetermined threshold value in order of size; and
selecting characteristics values not coincided with previously selected characteristics values from the lined characteristics values in order of great value as the predetermined number.

14. The method of claim 13, wherein a characteristics value (WFV) is calculated by following equation
$$\begin{matrix}WFV = \frac{( Sum\_gxx + Sum\_gyy - \sqrt{{( Sum\_gxx - Sum\_gyy )}^{2} + 4 Sum\_gxy} )}{2} \\ Sum\_gxx = {\sum }_{ = 1}^{W} gx \times gx \\ Sum\_gyy = {\sum }_{ = 1}^{W} gy \times gy \\ Sum\_gxy = {\sum }_{ = 1}^{W} gx \times gy\end{matrix}$$
wherein, Sum_gxx is the sum total of square of each pixel in a window in the Gₓ image, Sum_gyy is the sum total of square of each pixel in a window in the G_{y} image, and Sum_gxy is the sum total of values obtained by multiplying pixels in a window in the Gₓ image by pixels in a window placed on the same position in the G_{y} image.

15. The method of claim 12, wherein the characteristics tracing step includes the sub-steps of:
calculating a difference image of the noise-removed image in the horizontal and vertical axes and extracting characteristics of vehicles from the calculated difference image by predetermined window units; and
determining a search region on the basis of positions of the extracted characteristics and determining characteristics not less than a predetermined threshold value in the search region as vehicles.

16. The method of claim 12, wherein the characteristics tracing step includes the sub-steps of:
setting positions of characteristics extracted from the image as a reference template;
predicting positions of the extracted characteristics on a next image and determining positions of the predicted characteristics as a search region;
calculating a correlation coefficient between a window in the search region and the reference template; and
selecting a window showing a maximum correlation coefficient value among the calculated correlation coefficient values as new characteristics.

17. The method of claim 16, wherein the correlation coefficient (γ) is calculated by following equation
$$\begin{matrix}γ = \frac{{S}_{xy}}{{S}_{x} {S}_{y}} , - 1 \leq γ \leq + 1 \\ {S}_{xy} = \frac{1}{n - 1} \sum ( {X}_{k} - \overline{X} ) ( {Y}_{k} - \overline{Y} ) \\ {S}_{x} = \sqrt{\frac{1}{n - 1} \sum {( {X}_{k} - \overline{X} )}^{2}} \\ {S}_{xy} = \sqrt{\frac{1}{n - 1} \sum {( {Y}_{k} - \overline{Y} )}^{2}}\end{matrix}$$
wherein, γ is a correlation coefficient, Xₖ is a gray value of each pixel in a reference template window, \overline{X} is an average value of Xₖ, Yₖ is a gray value of each pixel in a window in the search region, and \overline{Y} is an average value of Yₖ.

18. The apparatus of claim 17, wherein the distance calculating step includes the sub-steps of:
recognizing vehicles on the basis of positions of the selected characteristics;
determining the recognized characteristics (vehicles) as stopped vehicles when position trace of the characteristics recognized as vehicles is smaller than a predetermined size for predetermined frames;
calculating a maximum and a minimum positions of the characteristics of the stopped vehicles in the horizontal and vertical axes; and
calculating a distance from the center mark of the maximum and minimum positions to a reference position in a traffic lane on the road as a queue length of the vehicles.
